(19) United States
(12) Patent Application Publication
(10) Pub. No.: US 2018/0125100 A1
(43) Pub. Date: May 10, 2018

(54) DRINK PRODUCING APPARATUS WITH DECARBONIZATION OF A LIQUID IN THE DISPENSING CONTAINER, HOUSEHOLD REFRIGERATION APPARATUS AND METHOD FOR OPERATING A DRINK PRODUCING APPARATUS

(71) Applicant: BSH HAUSGERAETE GMBH, MUENCHEN (DE)

(72) Inventors: KUDRET BAYSAL, GIENGEN BRENZ (DE); DELIA HAHN, HEIDENHEIM AN DER BRENZ (DE); MARCEL KIRSCHEN, GERSTHOFEN (DE); ANDREAS KLEINER, DORNSTADT (DE); CHRISTIAN MAYERSHOFER, GUNDREMMINGEN (DE); BERND METTEL, HERBRECHTINGEN (DE); CARSTEN WEISS, GIENGEN (DE)

(21) Appl. No.: 15/346,766

(22) Filed: Nov. 9, 2016

(51) Int. Cl. A23L 2/76; B67D 1/00; B67D 1/04; B67D 1/08; F25D 11/00; F25D 11/02; F25D 23/12; F25D 23/06; B01D 19/00

(52) U.S. Cl. CPC A23L 2/76; A23V 2002/00; B67D 1/04; B67D 1/0861; B67D 1/0078; B67D 1/0894; F25D 11/00; F25D 11/02; F25D 23/126; F25D 23/12; F25D 23/067; B01D 19/0047; B01D 19/0052; B01D 19/0063; B67D 1/0016

(57) ABSTRACT

A drink producing apparatus includes a dispensing unit for dispensing liquid from the drink producing apparatus, a dispensing container, which is formed for receiving a liquid addable to a drink by the drink producing apparatus in a first liquid state, a carbon dioxide addition unit for adding carbon dioxide into the dispensing container upon dispensing liquid from the dispensing container, a decarbonization device, by which the liquid remaining in the dispensing container and carbonized with the introduced carbon dioxide is decarbonized. The invention also relates to a household refrigeration apparatus and to a method.

### TECHNICAL FIELD

The invention relates to a drink producing apparatus with a dispensing container, which is formed for receiving a liquid addable to a drink by the drink producing apparatus. The drink producing apparatus moreover includes a dispensing unit, to which the dispensing container is connected for supplying the liquid from the dispensing container to the dispensing unit. Furthermore, the invention also relates to a household refrigeration apparatus with such a drink producing apparatus. The invention also relates to a method for operating a drink producing apparatus.

### PRIOR ART

From DE 196 15 106 A1, a method and a device for continuously producing soda water or soda-like water are known. A device is disclosed there, in which different liquids like lemonade, beer, wine can be present in different separate containers. Each container is connected to an own tap and is thus separated from the other container. Producing and dispensing a mixed drink of different liquids in the containers is not possible there in the interior of the system itself. Furthermore, the taps are far apart such that introducing liquids from different taps into a drinking vessel at the same time is not possible.

From WO 2007/141321 A2, a household refrigeration apparatus is known, which comprises a drink apparatus, which is formed for dispensing a drink at this household refrigeration apparatus itself.

Moreover, cold drink machines are also known, in which alcohol containing mixed drinks, for example cocktails, can be dispensed.

In known drink producing apparatuses for dispensing cooled drinks, mixing of the liquid jet with other additions upon dispensing is restricted.

Especially carbonized and thus liquids mixed with carbon dioxide lose carbon dioxide in filling into the vessel, whereby the quality of the drink is decreased.

Moreover, hygienic requirements are also accommodated. In known implementations, the liquid can heat in the lines of a line device and germ growth can occur. Especially in implementations, in which carbon dioxide is also led in a drink producing apparatus, for example to produce and store carbonized liquids, a liquid can also be undesirably carbonized. However, especially if this liquid is provided for dispensing without carbonization, this then results in undesired results in the drink production.

### Presentation of the Invention

It is the object of the present invention to provide a drink producing apparatus as well as a household refrigeration apparatus and a method, in which a liquid stored in the apparatus is not dispensed in an undesired degree of carbonization. It is also the object to particularly hygienically perform the leadion of liquid in the drink producing apparatus and to improve the cleaning of the components. It is also the object to reduce the exit of carbon dioxide from the drink producing apparatus, which is added in the production of carbonized liquids for drinks to be dispensed, and to more multi-functionally configure the employment of carbon dioxide.

This object is solved by a drink producing apparatus, a household refrigeration apparatus and a method according to the independent claims.

An aspect of the invention relates to a method for operating a drink producing apparatus. In this method, the drink producing apparatus is provided with a dispensing unit for dispensing liquid from the drink producing apparatus. Moreover, the drink producing apparatus is provided with a dispensing container. Liquid with a first liquid state is added into the dispensing container. The drink producing apparatus is provided with a carbon dioxide addition unit. The drink producing apparatus is moreover provided with a carbon dioxide line device, which is connected to the carbon dioxide addition unit for leading carbon dioxide from the carbon dioxide addition unit. The dispensing container is filled with the liquid in its first liquid state before dispensing a drink from the drink producing apparatus and the dispensing container is closed at its filling opening after filling such that it is in particular also closed in gas-tight manner at the filling opening. Leading the liquid from the dispensing container is performed and thereby reduction of the filling level of the liquid in the dispensing container is effected. Carbon dioxide is supplied into the dispensing container via the carbon dioxide line device upon leading the liquid out of the dispensing container and decrease of the filling level in the dispensing container resulting therefrom. By this supply of carbon dioxide, the liquid in the dispensing container is carbonized to a certain extent. Then, decarbonization of at least the liquid remaining in the dispensing container is effected after supplying the carbon dioxide into the dispensing container. By this method, it is allowed that by the addition of carbon dioxide into the dispensing container during this dispensing process, negative pressure does not arise there when the liquid is led out of the dispensing container. By performing this avoidance of the negative pressure explicitly with carbon dioxide, microbial growth and thus germ growth in the dispensing container is also at least considerably reduced due to the property of this specific gas. Since especially in dispensing a drink with a desired non-carbonized liquid then following, due to the optionally occurring carbonization of this liquid in the dispensing container, an optionally undesired state of the drink to be dispensed then results, therefore, this decarbonization of the remaining liquid is effected in this context in order not to dispense the optionally carbonized liquid from the dispensing container in this following further dispensing process, but to dispense the liquid then previously again decarbonized from the dispensing container. In that it is therefore again available in a virtually non-carbonized state by the decarbonization, it can then also be directly delivered to the dispensing unit if a drink is desired in the following dispensing process, which is to have this non-carbonized first liquid from the dispensing container.

In an advantageous implementation, after supplying the carbon dioxide into the dispensing container, the degree of carbonization of the remaining liquid is determined and a decarbonization is performed depending on this degree of carbonization. By this implementation, it can be avoided that a decarbonization operation is performed although this would not be required. Moreover, a very specific carbonization procedure can then also be selected by the determination of the degree of carbonization, whereby a fast and sufficient decarbonization is then effected very individually and thus depending on situation.

Preferably, a degree of carbonization of the liquid is reduced to a value less than or equal to 3.0 g/l in decarbonization. This is advantageous since with a carbonization greater than this value a human perceives haptic impressions, for example sparkling, in the mouth and on the tongue, respectively, when he consumes this liquid. However, especially if a user desires a drink, in which this liquid is at least proportionally contained non-carbonized, such a supply with a higher degree of carbonization in this respect can result in restricted enjoyment of consumption.

In decarbonization, a degree of carbonization of the liquid is preferably reduced to a value less than or equal to 2.5 g/l. Since with degrees of carbonization of greater than 2.5 g/l, altered impressions of taste arise in the drink, undesired impression of taste for a user is again reduced by this again reduced degree of carbonization.

As the decarbonization, the carbonized liquid in the dispensing container is preferably cooled to a temperature threshold value before further dispensing from the dispensing container such that a saturation pressure of the carbon dioxide in the liquid is reduced. Thus, by defined and specific cooling, decarbonization of the carbonized liquid can then also be already effected in the dispensing container itself.

Preferably, the temperature threshold value is determined equal to the temperature, at which the liquid is then dispensed from the dispensing unit in a following dispensing process. Thereby, this state is already provided in the dispensing container to particular extent, with which this liquid is then to be present in the drink to be dispensed. Undesired further deviations, which result in altered results at the dispensing unit, can thereby be avoided.

In a further advantageous implementation, the carbonized liquid is led from the dispensing container into an intermediate container of the drink producing apparatus and decarbonization of the carbonized liquid is performed on the way between the dispensing container and the intermediate container. Thus, the liquid present in non-carbonized manner in the dispensing container is then not carbonized in the dispensing container itself, but outside. Thereby, the decarbonization process is specified to a time, at which leadion of this carbonized liquid from the dispensing container, for example for intermediate storage in the intermediate container, or then for directly dispensing via this intermediate container to the dispensing unit is led anyway.

In a further aspect of the invention, the dispensing container is arranged at a higher level and thus in a higher height position than the intermediate container, and the liquid is decarbonized by fall down of the liquid on the way between the dispensing container and the intermediate container over a fall distance. By this defined higher fall distance, gas exchange of the liquid is improved and thereby the decarbonization is allowed.

A further aspect of the invention provides that a line connection between the dispensing container and the dispensing unit is charged with ambient air or an inert gas before introducing the liquid present in carbonized manner in the dispensing container into the line connection and the liquid is then introduced into this line connection for decarbonization. By this introduction of ambient air or an inert gas into this line connection, remaining carbon dioxide is actively discharged into the present line circuit or, if such a line circuit is not formed, delivered into the ambient air. Since carbon dioxide is heavier than air, the carbon dioxide therefore autonomously flows with gravity.

A further aspect of the invention in particular provides that the carbonized liquid is led from the dispensing container into an intermediate container and decarbonization of the liquid is performed in an intermediate container by swirling this liquid in the intermediate container. This can for example be performed by a swirling unit, which can for example be a magnetic stirrer. By this swirling, the gas exchange is promoted and thus the degree of carbonization of the liquid is reduced.

In a further implementation, it is provided that the decarbonization is performed by swirling by a nozzle or the decarbonization is performed by interface increase of the carbonized liquid by a nozzle. Thereby, the surface of the liquid is increased for gas exchange here too. The same can also be effected in subsequently dispensing the liquid into a drinking vessel.

Thus, the carbonized liquid can also be led from the dispensing container to the dispensing unit and a height of fall from a dispensing opening of the dispensing unit to a vessel, which is placed for receiving the liquid, can be set greater or equal to a height threshold value such that upon fall of the liquid over this height of fall, gas exchange is effected such that the liquid is decarbonized before impingement in the vessel.

A further aspect of the invention relates to a drink producing apparatus. The drink producing apparatus comprises a dispensing unit for dispensing liquid from the drink producing apparatus. The drink producing apparatus comprises a dispensing container, which is formed for receiving a liquid addable to a drink by the drink producing apparatus in a first liquid state. The drink producing apparatus comprises a carbon dioxide addition unit for adding carbon dioxide into the dispensing container upon dispensing liquid from the dispensing container. The drink producing apparatus comprises a decarbonization device, by which the liquid remaining in the dispensing container and carbonized with the introduced carbon dioxide can be decarbonized. The decarbonization can be performed in the dispensing container or outside of the dispensing container.

A further aspect of the invention relates to a household refrigeration apparatus with a housing, in which a receiving space for food is formed. The household refrigeration apparatus moreover comprises a drink producing apparatus. This drink producing apparatus comprises a dispensing unit for dispensing liquid from the drink producing apparatus. The drink producing apparatus comprises a dispensing container, which is formed for receiving a liquid addable to a drink by the drink producing apparatus in a first liquid state. The drink producing apparatus comprises a carbon dioxide addition unit for adding carbon dioxide into the dispensing container in dispensing liquid from the dispensing container. The drink producing apparatus comprises a decarbonization device, by which the liquid remaining in the dispensing container and carbonized with the introduced carbon dioxide can again be decarbonized.

Preferably, it is provided that the drink producing apparatus comprises a capsule with an addition medium separate from the dispensing container, which can then be added to the jet of the liquid in producing the mixed drink. Such an addition medium can be liquid, gelatinous or powdery. In this context, addition media individual both in taste and in color can then be present, which impart corresponding specifications to the mixed drink.

In particular, it is provided that the drink producing apparatus comprises at least one second dispensing container, which is formed for receiving a second liquid addable to the in particular cooled mixed drink by the drink producing apparatus, wherein this second dispensing container is connected to the dispensing unit of the drink producing apparatus for leading the second liquid from the second dispensing container to the dispensing unit, wherein the first liquid and the second liquid are mixed to the jet dispensed from the dispensing opening. In this configuration, thus, a mixed drink of two different liquids is already present at the dispensing opening, which can then in particular be mixed with the jet of the addition medium from the capsule.

It can be provided that a liquid, in particular the first liquid, is water or contains water and the second liquid is alcohol or contains alcohol.

In particular, the two liquids also have different freezing points.

In particular, the first dispensing container is cooled by a cooling device of the drink producing apparatus. The cooling device is in particular a refrigeration circuit. The refrigeration circuit in particular includes an evaporator thermally coupled to the dispensing container such that the dispensing container can be cooled by the cold energy of the evaporator and thus the first liquid in particular present in the dispensing container is then also cooled thereby.

In particular, the preferably present second dispensing container can also be cooled by the cooling device. Here too, the thermal coupling to a refrigeration circuit is in particular provided, which is preferably the refrigeration circuit, by which the first dispensing container is also cooled. Here too, it is preferably provided that the second dispensing container is thermally coupled to an own, separate evaporator and is cooled via the cold energy thereof. Especially if the two liquids have different freezing points, the cooling with separate cooling units, in particular separate evaporators, is advantageous to be able to individually adjust adequate temperatures without one of the two liquids freezing.

Implementations of an independent aspect of the invention relating to the drink producing apparatus are to be regarded as advantageous implementations of the other independent aspects of the drink producing apparatus.

Furthermore, the invention also relates to a household refrigeration apparatus for storing and preserving food, which comprises a housing, in which a receiving space for food is formed. The household refrigeration apparatus moreover includes a drink producing apparatus according to the first independent aspect of the invention or according to the second independent aspect of the invention. The household refrigeration apparatus can be a refrigerator or a freezer or a combined refrigerator-freezer.

In addition, it can also be provided that the drink producing apparatus is formed for receiving a capsule, in which additives, which can be added to the mixed drink, are contained. Additives can be powdery or gelatinous or also liquid. In this context, the capsule can then be introduced into a dispensing area of the drink producing apparatus and this ingredient of the capsule can then also be automatically dispensed or admixed or already be admixed upon dispensing the mixed drink.

In an advantageous implementation, it is provided that the drink producing apparatus is disposed in a receiving area of the household refrigeration apparatus in particular separate from the receiving space for food. This receiving area can be formed in an interior container bounding the receiving space with its walls. However, it can also be provided that the receiving area is formed in an interior container separate from this interior container bounding the receiving space with its walls. These interior containers or this interior container are or is disposed in the housing.

The receiving space, in particular only the receiving space, is closable on the front side by a door pivotably supported at the housing. In this context, it can be provided that the household refrigeration apparatus is formed such that only one receiving space is present, which is for example a refrigerating compartment or a freezing compartment, which is closable by an own door. However, it can also be provided that such a single receiving space is closable by two doors, which are swing doors. However, it is similarly possible that with two separate receiving spaces, for example a refrigerating space and a freezing space, each of these receiving spaces is closable by a separate door.

Preferably, the drink producing apparatus is accessible on the front side and exposed and not closed and covered by a door.

In an advantageous implementation, it is provided that the drink producing apparatus is arranged drawer-like in the receiving space and thus is retractable and extractable in depth direction of the household refrigeration apparatus. Thereby, the operability for dispensing mixed drinks can be simplified. An essential advantage of this configuration is to be regarded in that the accessibility to the housing of the mixed drink producing apparatus is simplified. In particular the accessibility to the containers and/or other further components in the housing is thereby allowed. It can then be provided that in the extracted state the interior of the housing of the drink producing apparatus can be accessed for example via openings in side walls closable by flaps.

The drink producing apparatus is also to be referred to as mixed drink producing apparatus if the drink to be dispensed comprises at least one liquid and an addition medium or at least two different liquids.

With indications of “top”, “bottom”, “front”, “rear”, “horizontal”, “vertical”, “depth direction”, “width direction”, “height direction” etc., the positions and orientations with intended use and intended arrangement of the apparatus and with an observer then standing in front of the apparatus and looking towards the apparatus are specified.

Further features of the invention are apparent from the claims, the figures and the description of figures. The features and feature combinations mentioned above in the description as well as the features and feature combinations mentioned below in the description of figures and/or shown in the figures alone are usable not only in the respectively specified combination, but also in other combinations without departing from the scope of the invention. Thus, implementations are also to be considered as encompassed and disclosed by the invention, which are not explicitly shown in the figures and explained, but arise from and can be generated by separated feature combinations from the explained implementations. Implementations and feature combinations are also to be considered as disclosed, which thus do not have all of the features of an originally formulated independent claim. Moreover, implementations and feature combinations are to be considered as disclosed, in particular by the implementations set out above, which extend beyond or deviate from the feature combinations set out in the relations of the claims.

### BRIEF DESCRIPTION OF THE DRAWINGS

Below, embodiments of the invention are explained in more detail based on schematic drawings. There show:

FIG. 1 a perspective partial representation of an embodiment of a household refrigeration apparatus according to the invention;

FIG. 2 a schematic representation of partial components of an embodiment of a drink producing apparatus according to the invention as it can be installed in the household refrigeration apparatus according to FIG. 1; and

FIG. 3 a schematic representation of partial components of an embodiment of a drink producing apparatus according to the invention.

### PREFERRED EMBODIMENTS OF THE INVENTION

In the figures, identical or functionally identical elements are provided with the same reference characters.

In the figures, identical or functionally identical elements are provided with the same reference characters.

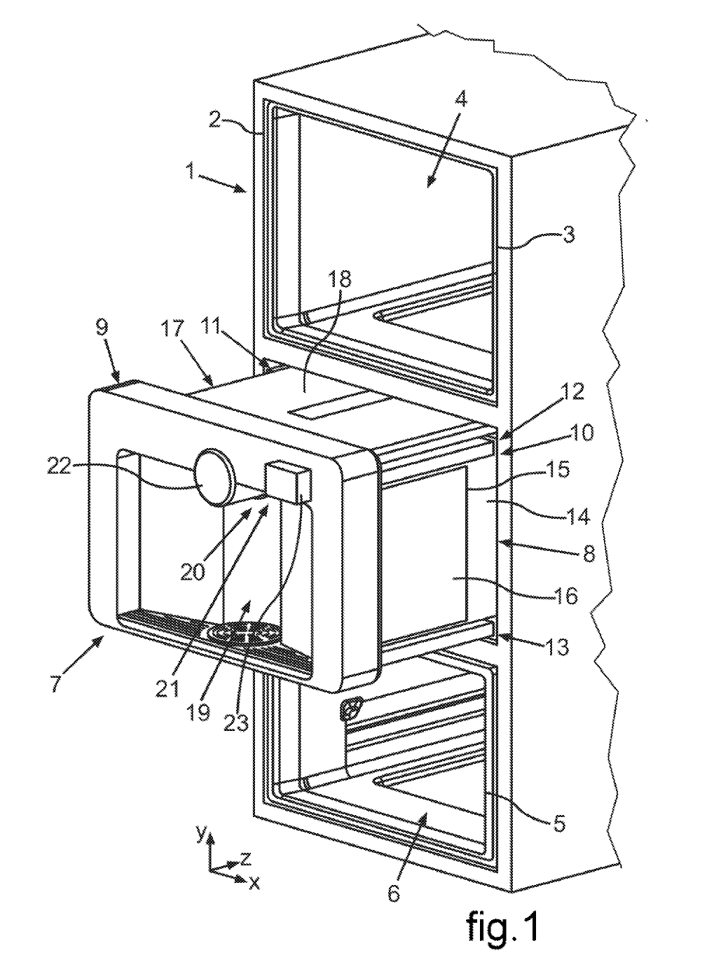

In FIG. 1, an embodiment of a household refrigeration apparatus 1 is illustrated in certain areas in a simplified perspective representation. Here, the household refrigeration apparatus 1 is for example a combined refrigerator-freezer, but can also be only a refrigerator or a freezer. The household refrigeration apparatus 1 is formed for storing and preserving food. It includes a housing 2, in which a first interior container 3 is disposed.

Walls of the interior container 3 bound a first receiving space 4 for food, wherein this receiving space 4 is a refrigerating compartment.

Moreover, the household refrigeration apparatus 1 includes a further interior container 5, which bounds a second receiving space 6 with its walls, which is a freezing compartment. The two receiving spaces 4 and 6 are separated from each other. In the shown embodiment, the receiving spaces 4 and 6 are disposed one above the other in vertical direction and thus in height direction (y-direction). In the embodiment, they are preferably closable by non-shown, respectively separate doors, which are in particular pivotably fastened to the housing 2.

Moreover, the household refrigeration apparatus 1 includes a drink producing apparatus 7, which is a mixed drink producing apparatus in the embodiment.

However, the drink producing apparatus 7 can also be formed as a separate independent apparatus and thus be installed independently of a household refrigeration apparatus 1 and operable independently thereof.

The drink producing apparatus 7 is disposed in a receiving area 8 of the housing 2. This receiving area 8 is separated from the receiving spaces 4 and 6. It can be provided that the receiving area 8 is bounded by walls of a separate interior container, which is also foamed in the housing 2. However, the receiving area 8 can also be formed integrated in the interior container 3 or the interior container 5.

In the embodiment, it is provided that the receiving area 8 is disposed between the receiving space 4 and the receiving space 6 in height direction.

The drink producing apparatus 7 is disposed accessible from the front side and thus from the front and the visible side. In particular, it is not closable and thus not coverable on the front side by a door.

The drink producing apparatus 7 comprises a housing 9.

In the embodiment, it is provided that the housing 9 and thus the entire mixed drink producing apparatus 7 can be extracted from and again retracted into the receiving area 8 in depth direction and thus in horizontal direction corresponding to the z-direction corresponding to a drawer. In FIG. 1, the completely extracted state is shown. However, the apparatus 7 can also be disposed fixedly installed.

Here, it is preferably provided that the horizontal displaceability is formed by a displacing device 10, which comprises multiple supporting positions. In the embodiment, it is provided that the displacing device 10 includes at least two, in particular four supporting positions. In the embodiment, they are formed as rails, which can also be extraction rails. In particular, here are disposed a first rail 11 in an upper left corner area, a second rail 12 in the upper right corner area, a third rail 13 in the lower right corner area and a further rail not recognizable in FIG. 1 in the lower left corner area. By this four-position support, a very secure and spread- and tilt-proof displacement, respectively, of the housing 9 is allowed.

Thus, the drink producing apparatus 7 is advantageously displaceably supported in the interior container 8. Advantageously, the displacing device 10 also comprises an extraction stop, by which the drink apparatus formed in particular as a drink producing apparatus 7 is secured in position in a completely extracted position shown in FIG. 1. Thus, over-extraction cannot be effected such that the drink producing apparatus 7 cannot fall out to the front and tilt downwards, respectively.

Advantageously, it is also provided that the displacing device 10 comprises a displacing protection, by which the drink producing apparatus 7 is disposed extraction-secured in the position completely retracted into the receiving area 8. Thereby too, undesired slipping out or protruding to the front then present is avoided. Undesired leakage or dripping of a liquid or hitting thereto is thereby prevented. This displacement protection can be a locking device. However, in addition or instead, a magnetic mount can for example also be provided.

Advantageously, an access 15 is formed at a vertical sidewall 14 of the housing 9, which is closed by a flap 16. After opening the flap 16, the interior of the housing 9 can be accessed such that the simple and unrestricted accessibility is allowed for purposes of exchange or filling. Additionally or instead, it can also be provided that a corresponding access is formed at an opposing further vertical sidewall 17 and/or at least one such access 15 is formed at a ceiling wall 18 of the housing 9.

Moreover, the drink producing apparatus 7 includes a recess or placing bay 19 on the front side, into which a drinking vessel can be placed, by which the mixed drink to be produced and dispensed by the drink producing apparatus 7 can then be collected. The drink producing apparatus 7 includes a dispensing unit 20 with in particular a single outlet or a dispensing opening 21. Preferably, it can be provided that an own outlet is respectively present for discharging each liquid from a container. Moreover, it can also be provided that an additive in powder form or gel form or further liquid form can additionally be admixed to this mixed drink to be produced, which can be produced and thus mixed from at least two different liquids. Thereto, it can in particular be provided that a capsule receptacle 22 is formed, into which a capsule comprising the mentioned additive or an addition medium can be inserted. Upon dispensing the mixed drink, this ingredient or additive is then removed from the capsule and added to the mixed drink in particular after dispensing into the drinking vessel effected via the dispensing opening 21.

Moreover, it can in particular be provided that the drink producing apparatus 7 comprises a capsule storage 23 or a capsule stock. A capsule or multiple capsules can be stored in this capsule storage 23 such that they are always present locally at the apparatus itself. In an advantageous implementation, it can be provided that this capsule storage 23 is cooled such that the capsules located therein can also be stored correspondingly cooled.

Preferably, it is provided that the capsule storage 23 can be opened by push-push mechanics and the capsules received therein are then freely accessible for example in the form of a displaceable storage in the form of a rail and for example can then be simply removed from above.

Moreover, it can also be provided that the drink producing apparatus 7 comprises a cartridge for admixing carbon dioxide into the mixed drink. Thereto, the accessibility for cartridge exchange is allowed via at least one present access 15. In an advantageous implementation, it is provided that the drink producing apparatus 7 is connected to a water connection external to household apparatus such that supply of water is for example allowed via a house water network. This has the additional advantage that a liquid to be added to the mixed drink as water does not have to be stored in a largely dimensioned container in the drink producing apparatus 7 but that this container can then be smaller dimensioned and can be refilled depending on demand and adapted to situation. It can then also be provided that such a water supply for producing the mixed drink is not supplied from the tank or the container provided for receiving this liquid in the drink producing apparatus 7, but additionally or instead can also be passed directly from this line to the dispensing unit 20 and thus also to the dispensing opening 21.

Thereby, in particular in production of hot drinks instead of a cold drink, the required energy for heating is reduced since the initial temperature of the water is higher. If carbonization of the mixed drink should then be desired, thus, this can be allowed via admixture of carbonized cold water, which is cooled in the drink producing apparatus 7, or by a carbonized second liquid, which is then present in the second container.

It is in particular provided that the drink producing apparatus 7 comprises a first container, in which a first liquid with a first freezing point, in particular water, is then provided or stored to then provide it for producing and dispensing a mixed drink depending on demand. Moreover, the drink producing apparatus 7 includes a second container separated therefrom, which is formed for receiving a second liquid different from the first liquid, which has a freezing point different form the first liquid. In particular, the first liquid is water and the second liquid is alcohol such that the mixed drink can also be an alcoholized mixed drink.

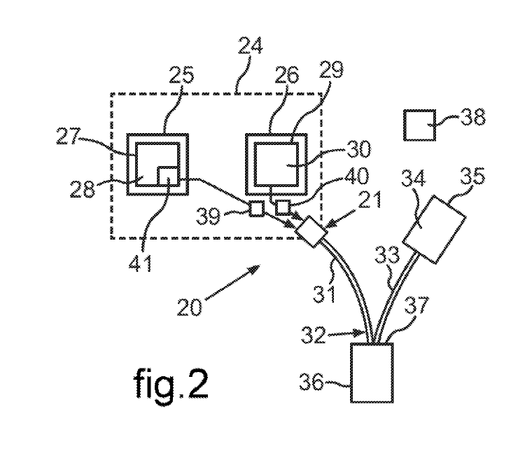

In FIG. 2, the household refrigeration apparatus 1 is shown with partial components of the drink producing apparatus 7 in a schematic representation. The household refrigeration apparatus 1 includes a refrigeration circuit 24, which is in particular a refrigeration circuit of the drink producing apparatus 7. In an advantageous implementation, this refrigeration circuit 24 includes a non-illustrated condenser, a compressor as well as a first evaporator 25 and a second evaporator 26 separate therefrom. The mixed drink producing apparatus 7 includes a first container or dispensing container 27, which is formed for receiving the first liquid 28 addable to the mixed drink, in the embodiment. The first dispensing container 27 is thermally coupled to the refrigeration circuit 24, in particular thermally coupled to the first evaporator 25. In an advantageous implementation, the first evaporator 25 surrounds the first dispensing container 27 on the outer side thereof at least in certain areas.

In the embodiment, it is provided that the drink producing apparatus 7 comprises a second container or dispensing container 29 separate from the first dispensing container 27, which is formed for receiving a second liquid 30 different from the first liquid, which can also be added to the mixed drink. Here too, it is preferably provided that the second evaporator 26 is thermally coupled to the second dispensing container 29, in particular surrounds it on the outer side thereof at least in certain areas.

In particular, it is provided that the first liquid 28 is or comprises water and the second liquid 30 is or contains alcohol.

In FIG. 2, dispensing of the two liquids 28 and 30 from the dispensing containers 27 and 29 is then illustrated by arrows in sketchy manner in the schematic representation, and the two liquids 28 and 30 are mixed to a common liquid jet 31 in an advantageous implementation. However, dispensing of a jet of only one of the two liquids 28 and 30 can also be provided.

In particular, it is provided that the jet 31 is formed after exit from the dispensing opening 21 at a place of meeting 32 with a jet 33 of an additive or addition medium 34, which is contained in a capsule 35 disposed in the mixed drink producing apparatus 7, after the dispensing opening 21, but before entry into a receiving vessel 36 with regard to the height position viewed in vertical direction. In particular, this place of meeting 32 is above a border 37 of the receiving vessel 36 in vertical direction. Mixing between the jet 31 and the jet 33 then desirably improved already before entry into the receiving vessel 36 is thereby achieved.

Therein, the receiving vessel 36 is placed in the placing bay 19 (FIG. 1).

The drink producing apparatus 7 also includes a control unit 38 for controlling the dispensing of the mixed drink.

In FIG. 2, it is preferably also provided that in the partial system, in which the liquid 28 is stored and led, a decompression chamber 39 is arranged. It is in particular arranged between the dispensing container 27 and the dispensing unit 20. The then in particular carbonized first liquid 28 is led into the decompression chamber 39 before leading out of the dispensing opening 21 and there reduced in its pressure. In particular, pressure reduction to about 2 bar is performed in the decompression chamber 39.

In an advantageous implementation, it is in particular provided that in addition or instead a further decompression chamber 40 is provided. It is arranged in the partial area or the system, in which the second liquid 30 is stored and led. It is correspondingly arranged between the further dispensing container 29 and the dispensing unit 20, in particular the dispensing opening 21. There too, pressure reduction can then be effected in the decompression chamber 40 if the second liquid 30 is provided in carbonized manner, in particular also again preferably to a pressure of about 2 bar.

In the schematic representation in FIG. 2, it is already apparent that in an embodiment, in which the drink producing apparatus 7 is formed as a mixed drink producing apparatus and thus provides two different liquids 28 and 30, which can be added to a drink to be dispensed, two separated systems are present, which provides storing and leading a liquid in the drink producing apparatus 7. These systems are preferably then respectively identically constructed and then each comprise the same or similar components in this context.

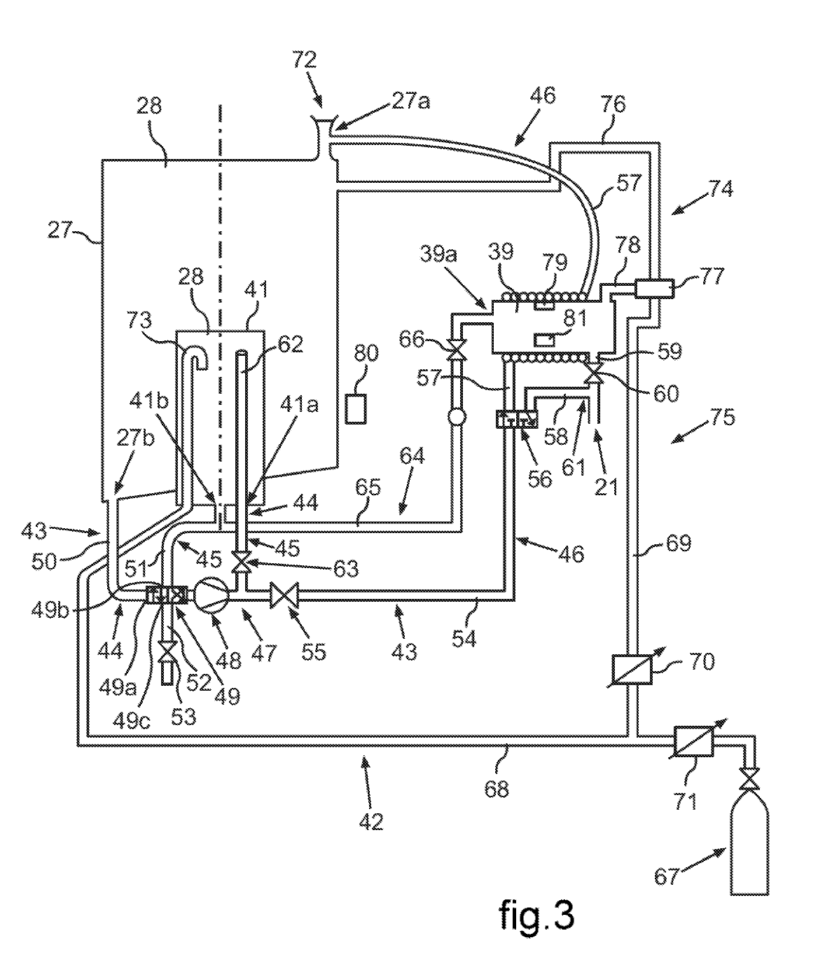

In FIG. 3, the drink producing apparatus 7 with partial components is shown in a schematic representation. In this context, it is to be mentioned that for example that system part is illustrated here, in which the first liquid 28 is stored and led. A corresponding construction, as it is shown in FIG. 3 and explained below, is then also present for the second liquid 30 in the drink producing apparatus 7 in corresponding manner. An explanation thereto is not explicitly performed and the facts set forth to FIG. 3 for one system part then also apply to this further system part, in which the second liquid 30 is stored and led.

In FIG. 3, the dispensing container 27 is shown, in which the first liquid 28 is contained in a first liquid state. This first liquid state is a non-carbonized state.

Moreover, a conditioning container 41 is shown in FIG. 3, which is separated from the dispensing container 27. This first liquid 28 is conditioned and provided in a second liquid state in this conditioning container 41, respectively. This second liquid state is a carbonized state.

The system shown in FIG. 3 moreover shows a line device 42 generally provided with the reference character, which represents a line network, by which the different components in the form of the dispensing container 27, the conditioning container 41 and the decompression chamber 39 are connected in fluid leading manner. In particular, the dispensing unit 20 with the dispensing opening 21 is also coupled to this line device 42 such that corresponding fluid leading connections to the dispensing container 27, the conditioning container 41 and the decompression chamber 39 exist here too.

The line device 42 comprises a first line connection 43, which is connected to the dispensing container 27 and the dispensing unit 20. Thus, the liquid 28 can be also directly led from the dispensing container 27 to the dispensing opening 21 via this first line connection 43. Thereby, the first liquid 28 can be led directly to the dispensing opening 21 from the dispensing container 27 without detour via the conditioning container 41 and without detour via the decompression chamber 39.

Moreover, the line device 42 includes a second line connection 44. The second line connection 44 is connected to the dispensing container 27 and the conditioning container 41. Moreover, the line device 42 includes a recirculation line connection 45. This recirculation line connection 45 is connected to an input 41a of the conditioning container 41 and to an output 41b of the conditioning container 41. The carbonized liquid 28 located in the conditioning container 41 in the second liquid state is circulated via this recirculation line connection 45.

In the embodiment, it is provided that the line device 42 additionally comprises a further recirculation line connection 46. This further recirculation line connection 46 is connected to an input 27a of the dispensing container 27 and to an output 27b of the dispensing container 27. The first liquid 28 contained in the dispensing container 27 in the first liquid state can be circulated via this further recirculation line connection 46.

An embodiment can also be provided, in which this further recirculation line connection 46 is not present. Similarly, an embodiment can be provided, in which the recirculation line connection 45 is not present, but the recirculation line connection 46 is then present.

The line device 42 comprises a line section 47, which is a constituent of the first line connection 43 and a constituent of the second line connection 44 and a constituent of the recirculation line connection 45. In the shown embodiment, it is moreover provided that this line section 47 is also a constituent of the further recirculation line connection 46 at the same time. This means that this line section is a simultaneous constituent of four line connections separately connected to different components of the drink producing apparatus 7.

A feed pump 48 is arranged in this line section 47, wherein it is in particular provided that this feed pump 48 is the only pump of the line device 42. This feed pump 48 is preferably a high-pressure pump. In particular, this line section 47 also comprises a 4/2-way valve 49. As is apparent, a line part 50, which opens into the output 27b of the dispensing container 27, is connected to a first port 49a of this 4/2-way valve 49. This line part 50 is a constituent of the first line connection 43 and also represents a constituent of the further recirculation line connection 46 in the embodiment.

Moreover, the line device 42 comprises a line part 51, which is connected to the output 41b of the conditioning container 41 and to a second port 49b of the 4/2-way valve 49. This line part 51 is also a recirculation line part of the recirculation line connection 45.

Moreover, the line device 42 includes a further line part 52, which represents a drain line. This line part 52 opens into a third port 49c of the 4/2-way valve 49. As is moreover apparent, a stop valve 53 is disposed in this line part 52, by which the drain or discharge of liquid from the line device 42 can be unblocked or stopped.

In flow direction of the first liquid 28, a further line part 54 is disposed after the first line part 50 and after the line section 47, which is a constituent of the first line connection 43 and is also a constituent of the further recirculation line connection 46 at the same time in the embodiment. This line part opens into a further stop valve 55, which is connected to the line section 47 on the other hand. Moreover, it is provided that this line part 54 opens into a further valve 56, wherein this further valve 56 is in particular a 3/2-way valve. As is furthermore apparent, a further line part 57 is connected to this further valve 56 on the one hand, connected to the input 27a of the dispensing container 27 on the other hand. Moreover, this line part 57 is laid multiple times turning around the outer side of the decompression chamber 39 such that a corresponding thermal coupling between this line part 57 and the decompression chamber 39 is achieved. In particular, cooling of the liquid in the decompression chamber 39 is thereby achieved since the first liquid 28 is preferably cooled stored in the dispensing container 27.

This line part 57 is therefore a constituent of the further recirculation line connection 46.

Moreover, a line part 58 is provided, which also opens into the valve 56 and is connected to the dispensing opening 21 on the other hand. This line part 58 is preferably then also a constituent of the first line connection 43, via which the first liquid 28 can be led from the dispensing container 27 then directly to the dispensing opening 21.

As is moreover apparent, the decompression chamber 39 also opens into the dispensing opening 21 by a line part 59. Thereby, the medium dispensed from the decompression chamber 39, namely the carbonized liquid 28 then brought to a lower pressure level, can be led directly to the dispensing opening 21. Here, it is in particular provided that a further stop valve 60 is arranged on the line path between the decompression chamber 59 and the dispensing opening 21. This stop valve 60 is preferably arranged upstream of an opening 61 in flow direction, at which the line part 58 opens into the line opening into the dispensing opening 21.

Moreover, it is provided that the recirculation line connection 45 comprises a line part 62 as a recirculation line part, which joins to the line section 47 downstream of it in flow direction of the liquid 28. Here too, it is provided that a further stop valve 63 is arranged between the line section 47 and this line part 62.

A further line connection 64 is formed between the conditioning container 41 and the decompression chamber 39. Thereto, a line part 65 is provided here too, which extends between an output 41b of the conditioning container 41 and an input 39a of the decompression chamber 39. Here, it is in particular provided that a valve 66 is arranged in this line part 65, which is also preferably a stop valve.

As is moreover shown in an example, the drink producing apparatus 7 includes a CO₂ container 67, by which carbon dioxide addition can be effected via a further line 68 to the conditioning container 41. In the embodiment, it is moreover provided that a connection between the container 67 and the decompression chamber 39 is formed via a further line part 69. Corresponding pressure controllers 70 and 71 are present in the line parts.

In the embodiment shown here, it is provided that the first line connection 43 comprises the line part 50, the line section 47, the line part 54 and the line part 58.

The second line connection comprises the line part 50, the line section 47 and the line part 62 in the shown embodiment.

The recirculation line connection 45 comprises the line part 51, the line section 47 and the line part 62 in the shown embodiment.

The further recirculation line connection 46 comprises the line part 50, the line section 47, the line part 54 as well as the line part 57, which are then recirculation line parts, in the shown embodiment.

In this context, a plurality of further line parts are also present in the embodiment, which are not associated with only one single line connection, but which are constituent of at least two line connections of the line device 42. The stop valves 55 and 63 each comprise two ports, into which the line section 47 opens at the one hand, further line parts 54 and 62, respectively, open at the other hand.

In an advantageous implementation, it is provided that at least one recirculation line connection is thermally coupled to a non-recirculation line connection such that the temperature level of the recirculation line connection can be transferred to the non-recirculation line connection. In this context, the thermal coupling can be realized by a heat exchanger, for example a thermally leading adhesive tape, which is preferably formed as a metallic adhesive tape. The thermal coupling between a recirculation line connection and a non-recirculation line connection can also be realized in a common insulation, which means that these two line connections are then surrounded by a common insulation. Similarly, it is possible that the thermal coupling between a recirculation line connection and a non-recirculation line connection is formed by a pipe-in-pipe system.

For example, it can be provided that a thermal coupling is formed between the line part 65 and the line part 54. In addition or instead, a thermal coupling can also be provided between the line part 65 and the line part 57. Preferably, pressure regulation to 2 bar is possible in the line part 69 such that the liquid then present in the decompression chamber 39 is reduced to a corresponding pressure level. On the other hand, it can be provided that a pressure of about 4 bar is set by the pressure controller 71 such that the first liquid 28 in the conditioning container 41, in which the liquid 27 is conditioned with the carbon dioxide, is on a correspondingly high pressure level.

Moreover, the dispensing container 27 comprises a filling opening 72, via which the first liquid 28 can be introduced. In particular, a filter can also be additionally present there.

Moreover, it can be provided that a check valve is also arranged in a line part 73 opening into the conditioning container 41, which introduces the carbon dioxide from the container 67.

Moreover, the line part 62 can comprise a nozzle for atomizing the liquid 28 to be introduced.

As is moreover shown in FIG. 3, the drink producing apparatus 7 is formed with a closed line circuit 74, which represents a carbon dioxide line device 75. Carbon dioxide in the drink producing apparatus 7 is circulated in this closed line circuit 74 and not discharged into the environment.

The carbon dioxide line device 75 and thus also in particular the closed line circuit 74 comprise the carbon dioxide addition unit 67. Besides the already explained line connections 68 and 69, which are the line connections of the carbon dioxide line device 75, the carbon dioxide line device 75 also comprises a further line connection 76. This line connection 76 is connected to the dispensing container 27 for leading carbon dioxide on the one hand, to a valve 77, which is in particular a 3/2-way valve, on the other hand. This line connection 76 is connected to the line connection 69 via this valve 77 on the one hand. Thereby, carbon dioxide can be directly led from the carbon dioxide addition unit 67 to the dispensing container 27 via the line connections 69 and 76.

On the other hand, the line connection 76 is also connected to the decompression chamber 39 via this valve 77. Thus, it can also be allowed that carbon dioxide is led from the decompression chamber 39 into the dispensing container 27 via the line connection 78, the valve 77 and the line connection 76. Moreover, it is possible that carbon dioxide can be led from the carbon dioxide addition unit 67 directly into the decompression chamber 39 via the line connections 69 as well as the valve 77 and the line connection 78. As is apparent, each line connection of the carbon dioxide line device 75 opens into a further component of the drink producing apparatus 7, in particular respectively into a further component, in which liquid is contained, in particular a container.

Independently of the configuration of the carbon dioxide line device 75 preferably as a closed line circuit 74, the carbon dioxide line device 75 can comprise the line connection 76, which is connected to the decompression chamber 39 and the dispensing container 27 for leading carbon dioxide from the decompression chamber 39 to the dispensing container 27.

In a further advantageous configuration, in addition or instead, it can be provided that the carbon dioxide line device 75 comprises a line connection 69 and a line connection 78, which is connected to the decompression chamber 39 and the carbon dioxide addition unit 67 for leading carbon dioxide from the carbon dioxide addition unit 67 to the decompression chamber 39.

In a further advantageous implementation, in addition or instead, it can be provided that the carbon dioxide line device 75 comprises a line connection 69 and a line connection 76, which is connected to the dispensing container 27 and the carbon dioxide addition unit 67 for leading carbon dioxide from the carbon dioxide addition unit 67 to the dispensing container 27.

In advantageous implementation, the drink producing apparatus 7 comprises a filling level capturing unit 79, which is formed for capturing a filing level of the carbonized liquid present in the decompression chamber 39. The filling level capturing unit 79 can comprise one or more detection units, which can be disposed in the decompression chamber 39 and/or outside of the decompression chamber 39. The filling level capturing unit 39 can comprise at least one ultrasonic sensor and/or at least one optical sensor and/or at least one capacitive sensor and/or at least one gas sensor and/or at least one float switch and/or at least two electrodes.

For operating the drink producing apparatus 7 and thus for producing and dispensing a drink, in an advantageous implementation, the dispensing container 27 is first completely filled with the first liquid 28. For example, this can be effected via a canister, which is coupled to the dispensing container 27 via the filling opening 72. After completely filling the dispensing container 27, it is then closed at its filling opening 72 in gas-tight manner by a mechanical or electrical valve.

If a drink is then subsequently to be dispensed and it for example is to comprise the liquid 28 from the dispensing container 27 in the non-carbonized state, thus, it can be led to the dispensing unit 20 and in particular to the dispensing opening 21 via the already explained line paths and thus the line connections set forth. When this is effected, the filling level of the liquid 28 in the dispensing container 27 decreases. In order to avoid a negative pressure in the dispensing container 27, carbon dioxide is introduced into the dispensing container 27 at the same time with the dispensing of the liquid 28 from the dispensing container 27, namely there not directly into the still present liquid 27, but into the arising clearance or cavity. This arising cavity is therefore then filled with the carbon dioxide. Therein, this carbon dioxide can be supplied from the carbon dioxide addition unit 67 into the dispensing container 27 via the line connections 69 and 76. However, it can also be provided that carbon dioxide is led from the decompression chamber 39 into the dispensing container 27 via the line connections 78 and 76.

If a drink is to be dispensed, which comprises carbonized liquid, on the other hand, thus, the filling level in the dispensing container 27 then decreases here too, since this liquid 28 is then first led into the conditioning container 41, is carbonized there and is led into the decompression chamber 39 from there. In the decompression chamber 39, in which the carbonized liquid is then brought to a lower pressure level, this carbonized liquid is then led to the dispensing opening 21. Here, it is then in particular provided that in this procedure carbon dioxide is also again introduced into the dispensing container 27. This too is effected according to the above mentioned possibilities via the line connections 69 and 76 or here preferably via the line connections 78 and 76. For this pressure reduction of the pressure of the liquid in the decompression chamber 39, fresh air is not supplied into the decompression chamber 39, but carbon dioxide is also supplied, which is in particular supplied from the carbon dioxide addition unit 67 via the line connections 69 and 78.

Very generally and for all of the embodiments explained heretofore, it is moreover provided that the drink producing apparatus 7 comprises a decarbonization device, by which the liquid remaining in the dispensing container 27 and carbonized with the introduced carbon dioxide is decarbonized. Thus, if after the in particular complete filling of the dispensing container 27 with the liquid 28, the dispensing container 27, as already set forth above, is closed and leading the liquid 28 from the dispensing container 27 is then performed in a dispensing process, the filling level of this liquid 28 in the dispensing container 27 also reduces. At least temporarily at the same time with the leading of the liquid 28 out of the dispensing container 27 in this dispensing process, carbon dioxide is introduced into the dispensing container 27 via the carbon dioxide line device 75. This is effected such that undesired negative pressure in the dispensing container 27 is not effected. Moreover, germ formation in the dispensing container 27 is at least considerably reduced by the introduction of the carbon dioxide. Since the liquid 28 then still present in the dispensing container 27 can carbonize with the introduced carbon dioxide, decarbonization of this liquid is again desired especially if this remaining liquid 28 is to be dispensed and added to a drink as a non-carbonized liquid in a further subsequent dispensing process.

In this context, it can preferably be provided that after supplying the carbon dioxide into the dispensing container 27 and after terminating the dispensing process, the degree of carbonization of the liquid 28 in the dispensing container 27 is determined and it is decided depending on the degree of carbonization if decarbonization of this liquid is performed. This decarbonization can then be performed immediately or upon starting the subsequent dispensing process.

Decarbonization of the liquid 28 is performed such that the degree of carbonization of the liquid 28 is then reduced to a value less than or equal to 3.0 g/l, in particular is reduced to a value less than 2.5 g/l.

In an embodiment, as the decarbonization, the carbonized liquid 28 in the dispensing container 27 can be cooled to a temperature threshold value before further dispensing from the dispensing container 27 such that a saturation pressure of the carbon dioxide in this liquid 28 is reduced. In such an approach, the decarbonization can be performed in the dispensing container 27 itself. The temperature threshold value can preferably be determined equal to the temperature, at which the liquid 28 is then to be dispensed from the dispensing unit 20 in a subsequent dispensing process.

If it is provided that the carbonized liquid 28 is led into an intermediate container, for example the decompression chamber 39, after dispensing from the dispensing container 27, decarbonization of the liquid 28 can be performed on the way between the dispensing container 27 and this intermediate container, which is in particular the decompression chamber 39, in a further embodiment. Thereto, it can be provided in an advantageous implementation that the dispensing container 27 is arranged at a higher level and thus in a higher height position than the intermediate container and by fall down of the liquid 28 on the way between the dispensing container and the intermediate container over a defined fall distance, this liquid is then decarbonized upon falling down. By this higher fall distance, the gas exchange of the liquids is improved and thus the decarbonization is performed.

It can also be provided that a line connection between the dispensing container 27 and the dispensing unit 20 is charged with ambient air or an inert gas before introducing the liquid 28 present in carbonized manner in the dispensing container 27 into this line connection and the liquid 28 is only then introduced into this line connection for decarbonization.

In a further embodiment, it can be provided that the carbonized liquid 28 is led from the dispensing container 27 into an intermediate container, for example the decompression chamber 39, and decarbonization of the liquid is performed in this intermediate container by swirling this liquid in the intermediate container.

Generally, swirling for decarbonization of the liquid can be effected by a nozzle 81. Interface increase of the liquid can also be performed by a nozzle 81, wherein decarbonization is then also effected by this interface increase.

A further possibility of decarbonization outside of the dispensing container 27 can be effected in that the carbonized liquid 28 is led from the dispensing container 27 to the dispensing unit 20. A height of fall of the liquid 28 from a dispensing opening 21 of the dispensing unit 20 and the vessel 36 is set greater than or equal to a height threshold value such that upon fall of the liquid 28 over this height of fall gas exchange is effected such that the liquid is decarbonized before impingement in the vessel 36.

Since a plurality of different decarbonization operations was explained, a decarbonization device 80 is to be shown in FIG. 3 only in symbolic manner and neither in location nor in number. This decarbonization device 80 can be individually configured depending on the respectively presented different possibilities of a decarbonization operation and can be a single device or be constructed of multiple partial devices.

### LIST OF REFERENCE CHARACTERS

1 Household refrigeration apparatus
2 housing
3 interior container
4 first receiving space
5 interior container
6 second receiving space
7 mixed drink producing apparatus
8 receiving area
9 housing
10 displacing device
11 rail
12 rail
13 rail
14 sidewall
15 access
16 flap
17 sidewall
18 ceiling wall
19 placing bay
20 dispensing unit
21 outlet
22 capsule receptacle
23 capsule storage
24 refrigeration circuit
25 first evaporator
26 second evaporator
27 first dispensing container
28 first liquid
29 second dispensing container
30 second liquid
31 jet
32 place of meeting
33 jet
34 addition medium
35 capsule
36 vessel
37 border
38 control unit
39 decompression chamber
40 decompression chamber
41 conditioning container
41a input
41b output
42 line device
43 first line connection
44 second line connection
45 recirculation line connection
46 recirculation line connection
47 line section
48 feed pump
49 4/2-way valve
49a first port
49b second port
49c third port
50 line part
51 line part
52 line part
53 stop valve
54 line part
55 stop valve
56 valve
57 line part
58 line part
59 line part
60 stop valve
61 opening
62 line part
63 stop valve
64 line connection
65 line part
66 valve
67 carbon dioxide addition unit
68 line
69 line part
70 pressure controller
71 pressure controller
72 filling opening
73 line part
74 closed line circuit
75 carbon dioxide line device
76 line connection
77 valve
78 line connection
79 filling level capturing unit
80 decarbonization device
81 nozzle

1. Method for operating a drink producing apparatus, in which the following steps are performed:
providing the drink producing apparatus with a dispensing unit for dispensing liquid from the drink producing apparatus,
providing the drink producing apparatus with a dispensing container,
providing the drink producing apparatus with a carbon dioxide addition unit,
providing the drink producing apparatus with a carbon dioxide line device, which is connected to the carbon dioxide addition unit for leading carbon dioxide from the carbon dioxide addition unit,
filling the dispensing container with the liquid before dispensing a drink from the drink producing apparatus and closing the dispensing container after filling,
leading the liquid from the dispensing container and thereby reduction of the filling level of the liquid in the dispensing container,
supplying carbon dioxide via the carbon dioxide line device into the dispensing container upon leading the liquid out and decrease of the filling level in the dispensing container,
decarbonizing at least the liquid remaining in the dispensing container after supplying the carbon dioxide into the dispensing container.

2. Method according to claim 1, wherein after supplying the carbon dioxide into the dispensing container, the degree of carbonization of the liquid is determined and decarbonization is performed depending on the degree of carbonization.

3. Method according to claim 1, wherein a degree of carbonization of the liquid is reduced to a value less than or equal to 3.0 g/l upon decarbonization.

4. Method according to claim 1, wherein the carbonized liquid in the dispensing container is cooled to a temperature threshold value before further dispensing from the dispensing container as the decarbonization such that a saturation pressure of the carbon dioxide in the liquid is reduced.

5. Method according to claim 4, wherein the temperature threshold value is determined equal to the temperature, at which the liquid is dispensed from the dispensing unit in a subsequent dispensing process.

6. Method according to claim 1, wherein the carbonized liquid is led from the dispensing container into an intermediate container and a decarbonization of the liquid is performed on the way between the dispensing container and the intermediate container.

7. Method according to claim 6, wherein the dispensing container is arranged in a higher height position than the intermediate container and the liquid is decarbonized by fall down of the liquid on the way between the dispensing container and the intermediate container over a fall distance.

8. Method according to claim 1, wherein a line connection between the dispensing container and the dispensing unit is charged with ambient air or an inert gas before introducing the liquid present in carbonized manner in the dispensing container into the line connection and the liquid is then introduced into this line connection for decarbonization.

9. Method according to claim 1, wherein the carbonized liquid is led from the dispensing container into an intermediate container and a decarbonization of the liquid is performed in the intermediate container by swirling this liquid in the intermediate container.

10. Method according to claim 1, wherein the decarbonization is performed by swirling by a nozzle or an interface increase by a nozzle.

11. Method according to claim 1, wherein the carbonized liquid is led from the dispensing container to the dispensing unit and a height of fall of the liquid from a dispensing opening of the dispensing unit and a vessel for receiving the liquid is set greater than or equal to a height threshold value such that upon fall of the liquid over the height of fall, a gas exchange is effected such that the liquid is decarbonized before impingement in the vessel.

12. Drink producing apparatus comprising:
a dispensing unit for dispensing liquid from the drink producing apparatus,
a dispensing container, which is formed for receiving a liquid addable to a drink by the drink producing apparatus in a first liquid state,
a carbon dioxide addition unit for adding carbon dioxide into the dispensing container upon dispensing liquid from the dispensing container,
a decarbonization device, by which the liquid remaining in the dispensing container and carbonized with the introduced carbon dioxide is decarbonized.

13. Household refrigeration apparatus comprising a housing, in which a receiving space for food is formed, and comprising a drink producing apparatus comprising:
a dispensing unit for dispensing liquid from the drink producing apparatus,
a dispensing container, which is formed for receiving a liquid addable to a drink by the drink producing apparatus in a first liquid state,
a carbon dioxide addition unit for adding carbon dioxide into the dispensing container upon dispensing liquid from the dispensing container,
a decarbonization device, by which the liquid remaining in the dispensing container and carbonized with the introduced carbon dioxide is decarbonized.
